(19) United States
(12) Patent Application Publication
(10) Pub. No.: US 2026/0264253 A1
(43) Pub. Date: Sep. 10, 2026

(54) ROBOT CONTROL SYSTEM

(71) Applicant: JOHNAN Corporation, Uji-shi, Kyoto (JP)

(72) Inventors: Kozo MORIYAMA, Uji-shi (JP); Shin KAMEYAMA, Uji-shi (JP); Truong Gia VU, Uji-shi (JP)

(73) Assignee: JOHNAN Corporation, Uji-shi, Kyoto (JP)

(21) Appl. No.: 19/166,893

(22) PCT Filed: Mar. 5, 2024
(86) PCT No.: PCT/JP2024/008312

§ 371 Date: Sep. 19, 2025

(30) Foreign Application Priority Data
Mar. 31, 2023 (JP) 2023-058133

(51) Int. Cl. B25J 9/16

(52) U.S. Cl. CPC B25J 9/1697; B25J 9/1669

(57) ABSTRACT

When treating a workpiece by a robot hand, actual image information is compared to estimated image information. The actual image information is the image information of the workpiece obtained by imaging by the imaging device at a predetermined position closer to the workpiece from a position having a predetermined distance from the workpiece, while the estimated image information is the image information of the workpiece estimated to be obtained by imaging by the imaging device at the predetermined position when it is assumed that the workpiece has not moved for a period when the robot arm moves together with the imaging device to the predetermined position. When the estimated image information and the actual image information match, the operation to treat the workpiece is executed using object information including distance information held in an object information holding section.

### TECHNICAL FIELD

The present invention relates to a robot control system. In particular, the present invention relates to improvement of robot control when the robot treats an object (for example, when the robot grips the object or processes the object).

### BACKGROUND ART

Conventionally, a robot control system disclosed, for example, by Patent Document 1 and Patent Document 2 is known as a system to grip and transport an object using a robot. In the robot control system disclosed in the above Patent Documents, the robot grips an object (for example, grips the object using a robot hand provided at a tip part of a robot arm) while measuring a distance to the object (recognizing the position of the object) by taking images of the object by an imaging device provided on the tip part of the robot arm.

In particular, Patent Document 1 discloses a system in which when pattern matching fails to specify a feature part of an object on an image obtained by an imaging device, a robot arm is operated to change relative positions or relative postures among the object, the imaging device, and an illumination device, so that an image of the object is once again taken and that the pattern matching is once again performed to the image thus newly obtained.

Also, Patent Document 2 discloses a system in which sensing results by an imaging device (sensor part) provided on a robot arm are analyzed for the purposes of: specifying an object to be gripped in an actual gripping operation and thus controlling the movement of the robot arm to grip the object to be gripped in the actual gripping operation; and specifying the sensing position for a next gripping operation and updating the information on the sensing position.

### PRIOR ART DOCUMENTS

### Patent Documents

Patent Document 1: JP 2015-160264 A
Patent Document 2: JP 2020-040143 A

### SUMMARY OF THE INVENTION

### Problem to be Solved by the Invention

However, the Patent Documents as mentioned above do not consider at all a case where the object moves while the robot arm is approaching the object. Generally, a three-dimensional camera is adopted as an imaging device provided on a tip part of the robot arm. However, the three-dimensional camera has a limited range for measuring the distance to an object. That is, since the three-dimensional camera measures the distance to the object using triangulation, it cannot measure the distance to the object when the distance to the object is smaller than a predetermined distance because the parallax becomes too large. Hereinafter, the range within which the distance to the object can be measured is referred to as a “measurable range”. Not only the passive type imaging devices but also the active type imaging devices have the measurable range.

In the case where the object does not move when the robot arm is approaching the object, the object can be reliably gripped using information on the distance to the object (i.e. positional information of the object) that is measured in the measurable range, and also using information on the shape of the object and the like. However, in the case where the object moves when the imaging device is located outside the measurable range while the robot arm is approaching the object, it is not possible to grip the object using the information on the distance to the object that is measured in the measurable range. Furthermore, sometimes the robot hand may collide with the object, which causes degradation of the object.

The problems as described above may occur not only in the case of using collaborative robots represented by the robots that grip and transport the object, but also in the case of industrial robots. Also, these problems may occur in various operations to treat the object, not only when the robot hand grips the object, but also when the robot processes the object.

The present invention was made in consideration of the above circumstances, an object of which is to provide a robot control system in which it is determined whether an object has moved or not when a robot arm is approaching the object so that a robot can be operated according to a determination result.

### Means for Solving the Problems

As means for solving the above problems, a robot control system of the present invention is a system to control a robot that treats an object based on image information of the object that is obtained by imaging the object by an imaging device provided on a robot arm of the robot. The robot control system includes: an object information holding section; an estimated image information generating section; a comparison section; and a control switching section. The object information holding section holds object information including distance information of the object. The distance information is calculated based on the image information obtained by imaging by the imaging device located at a position having a predetermined distance from the object. The estimated image information generating section generates estimated image information of the object based on the object information held in the object information holding section. The estimated image information of the object is estimated to be obtained by imaging by the imaging device at a predetermined position closer to the object in the case where it is assumed that the object has not moved for a period when the robot arm moves together with the imaging device from the position having the predetermined distance from the object to the predetermined position. The comparison section compares the estimated image information generated by the estimated image information generating section to actual image information of the object that is obtained by imaging by the imaging device at the predetermined position. The control switching section performs an operation to treat the object using the distance information held in the object information holding section when the actual image information and the estimated image information match each other as a comparison result by the comparison section, while it does not perform the operation to treat the object using the distance information held in the object information holding section when the actual image information and the estimated image information do not match each other.

The term “estimated image information” here means a synthesized image (image information obtained by synthesizing multiple pieces of image information) or a set of feature points (one or more feature points) that is sufficient to specify the position of the object, which is described later. Also, the phrase “the actual image information and the estimated image information match each other” here describes a concept including the following cases: the case where these kinds of information (features of the information) match each other; and the case where these kinds of information are considered to be the same.

With the above-described configuration, when the object is treated by the robot, the actual image information is compared to the estimated image information. The actual image information is the image information of the object obtained by imaging by the imaging device at the predetermined position closer to the object from the position having the predetermined distance from the object, while the estimated image information is the image information (a set of feature points as described above) of the object estimated to be obtained by imaging by the imaging device at the predetermined position when it is assumed that the object has not moved for a period when the robot arm moves together with the imaging device to the predetermined position. As the comparison result, when the estimated image information and the actual image information match each other or are considered to be the same (in other words, the features of the estimated image information and the features of the actual image information match each other or are considered to be the same), the object has not moved. Thus, even when the actual image information is the information that cannot give the distance information of the object (i.e. even when it is the information obtained at the position outside the measurable range), it is possible to appropriately treat the object using the distance information (i.e. distance information held in the object information holding section). Therefore, the operation to treat the object is executed using the distance information. On the other hand, when the estimated image information and the actual image information do not match each other (including the case where it is considered that they do not match each other), the object may have moved and it may not be possible to appropriately treat the object using the distance information. Thus, the operation to treat the object using the distance information is not executed. In this way, it is possible to appropriately treat the object while determining whether the object has moved or not when the robot arm is approaching the object.

Specifically, in the robot control system, when the control switching section does not perform the operation to treat the object, the object information held in the object information holding section is deleted, and imaging by the imaging device is performed at the position having the predetermined distance from the object so as to perform once again the operation to hold the object information including the distance information in the object information holding section.

That is, in the robot control system, when there is a possibility that the object has moved, it is determined that it may not be possible to appropriately treat the object using the distance information held in the object information holding section. Thus, the object information including the distance information on the thus-moved object is newly obtained so that it is held in the object information holding section. In this way, it is possible to appropriately treat the object even after the object has moved.

Also in the robot control system, it is preferable that an image information update section is further included, and that, when a plurality of pieces of image information is obtained by imaging by the imaging device at respective positions that have different distances to the object and from where the distance information is acquired, the image information update section causes the object information holding section to hold the object information including the distance information of the object, which is calculated based on the image information obtained at a position having the closest distance to the object.

The image (image information) obtained by imaging by the imaging device can be obtained as clear image information as the distance from the object is reduced. Thus, by causing the object information holding section to hold the object information including the distance information of the object, which is calculated based on the image information obtained at a position having the closest distance to the object, it is possible to highly accurately recognize the distance to the object, and thus to obtain high accuracy in operation to treat the object.

Also in the robot control system, an image information update section may also be included. When a plurality of pieces of image information is obtained by imaging by the imaging device at respective positions that have different distances to the object and from where the distance information is acquired, the image information update section may select the clearest image information and may cause the object information holding section to hold the object information including the distance information of the object, which is calculated based on the selected image information.

With the above-described configuration also, it is possible to highly accurately recognize the distance to the object, and thus to obtain high accuracy in operation to treat the object.

Also in the robot control system, an image information update section may be included. When a plurality of pieces of image information is obtained by imaging by the imaging device at respective positions that have different distances to the object and from where the distance information is acquired, the image information update section may synthesize the plurality of pieces of image information and may cause the object information holding section to hold the object information including the distance information of the object, which is calculated based on the synthesized image information.

For example, when some pieces of image information respectively have missing parts and furthermore when the respective missing parts are different from one another, such a missing part of the image (image information) is synthesized and complemented with another image (image not having this missing part). In this way, it is possible to generate the image information with high accuracy. By causing the object information holding section to hold the object information including the distance information of the object, which is calculated based on the image information as described above, it is possible to highly accurately recognize the distance to the object, and thus to obtain high accuracy in operation to treat the object.

Also in the robot control system, a viewpoint change instruction section may be included. When the actual image information and the estimated image information match each other as the comparison result by the comparison section, the viewpoint change instruction section may cause the imaging device to image the object from a direction different from the imaging direction of the imaging device from which the actual image information is obtained.

For example, as to the gripping position when the object is gripped, it is preferable to grip the center position or the center of gravity position of the object. For this reason, it is necessary to recognize the general shape of the object. Therefore, by causing the imaging device to image the object from a direction different from the imaging direction of the imaging device from which the actual image information is obtained, it is possible to recognize the general shape of the object, which leads to an appropriate operation to treat the object (for example, an operation to grip the center position or the center of gravity position of the object).

### Effects of the Invention

In the present invention, when a robot treats an object, estimated image information and actual image information are compared. As a comparison result, when the estimated image information and the actual image information match each other, an operation to treat the object is performed using distance information held in an object information holding section. In this way, it is possible to appropriately treat the object while determining whether the object has moved or not when the robot arm is approaching the object.

### BRIEF DESCRIPTION OF THE DRAWINGS

FIG. 1 is a diagram for explaining a schematic configuration of a robot unit and an operation to take an image of an object according to an embodiment.

FIG. 2 is a block diagram indicating a control system of the robot control system.

FIG. 3 is a diagram exemplarily illustrating an image of the object obtained by an initial imaging operation.

FIG. 4 is a diagram for explaining the operation to take an image of the object after a posture of the robot is changed.

FIG. 5 is a series of diagrams for explaining an operation to compare images when the object does not move.

FIG. 6 is a series of diagrams for explaining the operation to compare images when the object has moved.

FIG. 7 is a series of diagrams for explaining synthesis processing of two images.

FIG. 8 is a diagram exemplarily indicating an image of the object obtained by the imaging operation from a first different viewpoint.

FIG. 9 is a diagram exemplarily indicating an image of the object obtained by the imaging operation from a second different viewpoint.

FIG. 10 is a flowchart indicating a processing procedure for object gripping operation.

### MODES FOR CARRYING OUT THE INVENTION

Hereinafter, an embodiment of the present invention will be described with reference to the drawings. In this embodiment, a robot control system of the present invention is applied to a control system to grip an object (hereinafter occasionally referred to as a “workpiece”) by a robot hand provided on a tip part of a robot arm of a collaborative robot. However, the application of the robot control system of the present invention is not limited thereto.

### Configuration of Robot Unit

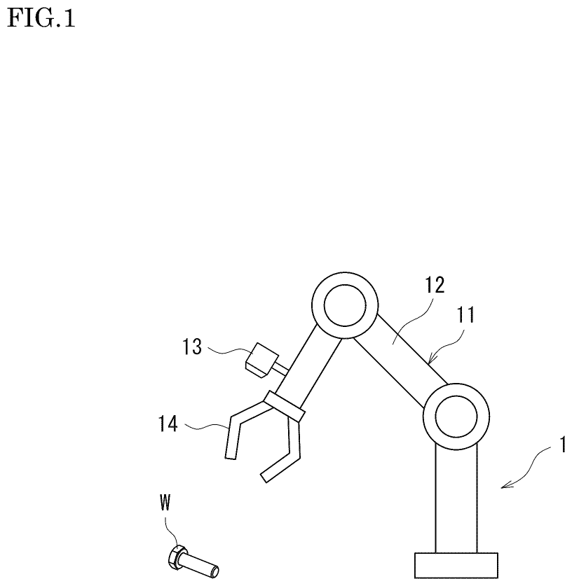

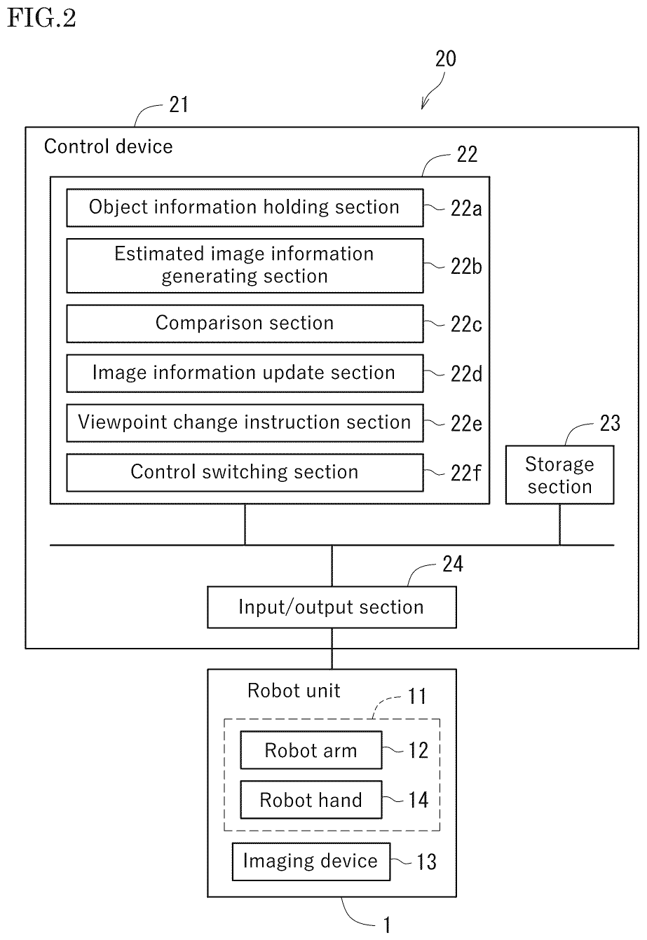

FIG. 1 is a diagram for explaining a schematic configuration of a robot unit 1 to which a robot control system 20 (see FIG. 2) according to this embodiment is applied, and also for explaining an operation to take an image of an object. The robot unit 1 includes: a robot 11 that performs operations to grip and transport a workpiece W placed on a workbench (not shown); and an imaging device 13 attached to a tip part of a robot arm 12 of the robot 11. The robot unit 1 is a space saving unit thanks to its configuration in which the imaging device 13 is attached to the tip part of the robot arm 12.

The robot unit 1 is used in cell production lines. For example, the workpiece W placed on a predetermined position (picking position) of a first workbench is transported, by the robot 11, from the position of the first workbench to a predetermined position (placing position) of a second workbench, so that a worker assembles the workpiece W on the second workbench.

The robot 11 includes: the robot arm 12 constituted of a multi-axis arm: and a robot hand 14 that is provided on a tip part of the robot arm 12 as an end effector. The robot arm 12 is provided to move the robot hand 14 to the predetermined position, and the robot hand 14 is provided to grip the workpiece W.

The imaging device 13 attached to the tip part (in the vicinity of the position on which the robot hand 14 is provided) of the robot arm 12 is, for example, a three-dimensional camera such as an RGB-D camera. The imaging device 13 takes an image of the workpiece W placed on the workbench, and outputs information on the taken image (image information) to a control device 21 (see FIG. 2) of the robot control system 20. The image information taken by the imaging device 13 is used as information for recognizing the shape and the position of the workpiece W (the position obtained based on the distance to the workpiece W) so as to grip the workpiece W, as described later.

Since the imaging device 13 is a three-dimensional camera, the range within which the distance to the workpiece W can be measured is limited to the range as the measurable range, as described above. Therefore, in the case where the workpiece W moves when the imaging device 13 is located outside the measurable range while the robot arm 12 is approaching the workpiece W to grip the workpiece W by the robot arm 14, it is not possible to grip the workpiece W using the information on the distance to the workpiece W that is measured in the measurable range.

In order to solve the above problem, the robot control system 20 according to this embodiment determines whether the workpiece W has moved or not when the robot arm 12 is approaching the workpiece W so as to control the robot 11 according to the determination result. Hereinafter, the robot control system 20 is specifically described.

FIG. 2 is a block diagram indicating a control system of the robot control system 20 according to this embodiment. As shown in FIG. 2, the control device 21 is provided as the control system of the robot control system 20 so as to control the robot unit 1. The control device 21 is provided as a computer that includes: an arithmetic section (a processor such as a CPU) 22; a storage section (a ROM or the like) 23; and an input/output section 24.

The storage section 23 stores an operation program and the like to control the robot unit 1.

The arithmetic section 22 calculates control instruction information to control the robot unit 1 by executing arithmetic processing based on a program (operation program) and the like stored in the storage section 23.

The input/output section 24 can receive the image information obtained by imaging by the imaging device 13, and also can transmit the control instruction information and the like to the robot unit 1.

The arithmetic section 22 includes, as a function section realized by the program: an object information holding section 22a; an estimated image information generating section 22b; a comparison section 22c; an image information update section 22d; a viewpoint change instruction section 22e; and a control switching section 22f. Hereinafter, respective functions of the above sections are overviewed.

The object information holding section 22a holds information on the workpiece W (object information). The information on the workpiece W includes information on the distance to the workpiece W, which is calculated by the image information obtained by imaging by the imaging device 13 located at a position having a predetermined distance from the workpiece W.

More specifically, the object information holding section 22a controls the operation of the robot arm 12 (controls by transmitting the control instruction information to the robot unit 1) such that the imaging device 13 is located in the measurable range, and furthermore acquires the image information obtained by imaging the workpiece W by the imaging device 13 located in the measurable range via the input/output section 24. Hereinafter, the imaging operation at this position at the time of starting the operation to grip the workpiece W is referred to as an “initial imaging operation”. Since the measurable range of the imaging device 13 is recognized in advance, the posture of the robot arm 12 can also be set in advance, with which the workpiece W is located within the field of view of the imaging device 13 and furthermore the distance between the imaging device 13 and the workpiece W falls into the measurable range. In order to obtain the above posture, the control instruction information is transmitted from the control device 21 to the robot unit 1, and thus the operation of the robot arm 12 is controlled such that the imaging device 13 is located in the measurable range.

Then, the imaging device 13 is caused to perform the imaging operation (initial imaging operation), and the distance to the workpiece W is calculated using the publically known triangulation based on the image information obtained by the initial imaging operation. This distance information is held in the object information holding section 22a. Also, based on the image information of the workpiece W, information on the posture of the workpiece W and information on positions of respective points of an outer edge and the like of the workpiece W are held.

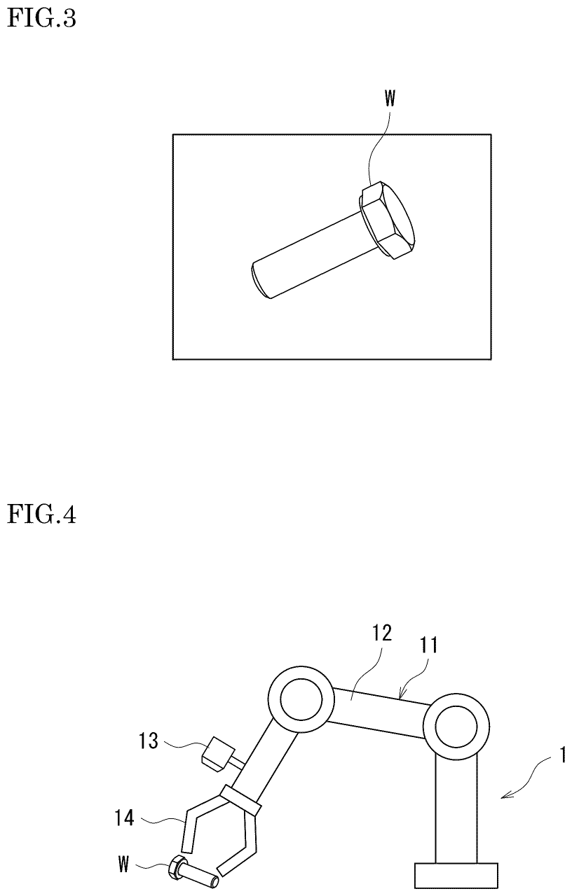

FIG. 1 shows the operation to take an image of an object (initial imaging operation) in the state in which the imaging device 13 is located in the measurable range. Also, FIG. 3 shows an example of the image of the workpiece W taken by the imaging device 13 in the state shown in FIG. 1. From this image, it is possible to acquire the information on the distance to the workpiece W, and on the shape or the like of the workpiece W. These pieces of information (object information) are held in the object information holding section 22a. The object information holding section 22a also holds (updates) the object information in the same way as described above when the imaging device 13 takes, intermittently, the images of the workpiece W multiple times while approaching the workpiece W. The update operation will be described later.

The estimated image information generating section 22b generates estimated image information (a set of feature points as described above) of the workpiece W, which is estimated to be obtained by imaging by the imaging device 13 at a predetermined position closer to the workpiece W when it is assumed that the workpiece W has not moved for a period when the robot arm 12 moves together with the imaging device 13 from the position having the predetermined distance from the workpiece W to the predetermined position closer to the workpiece W.

More specifically, the image information of the workpiece W when it is assumed that the workpiece W has not moved is generated as the estimated image information based on information on the moving amount of the imaging device 13 approaching the workpiece W with respect to the position of the imaging device 13 at the time of performing the initial imaging operation. For example, since the positional information of the respective points of the outer edge and the like of the workpiece W is held, it is possible to calculate, based on the control instruction information, the moving direction and the moving amount of the respective points (i.e. the relative moving direction and the relative moving amount of the respective points obtained by the initial imaging operation) when the robot arm 13 is approaching the workpiece W in the case where it is assumed that the workpiece W has not moved. Thus, it is possible to generate the estimated image information at the time of approaching the workpiece W when it is assumed that the workpiece W has not moved.

The comparison section 22c compares the actual image information obtained by imaging by the imaging device 13 at the predetermined position closer to the workpiece W to the estimated image information generated by the estimated image information generating section 22b. When the workpiece W has not moved, the estimated image information and the actual image information are substantially the same image (i.e. the images substantially match each other). In contrast to the above, when the workpiece W has moved, the estimated image information and the actual image information are different from each other. Thus, by comparing these two kinds of image information, it is possible to determine whether the workpiece W has moved or not while the imaging device 13 is approaching the workpiece W (i.e. while the robot arm 12 moves, together with the imaging device 13, from the position having the predetermined distance from the workpiece W to the predetermined position closer to the workpiece W).

FIG. 4 shows an operation to take an image of the object by the imaging device 13 at the predetermined position closer to the workpiece W (i.e. object image taking operation after a posture of the robot is changed). The actual image information is acquired by this object image taking operation.

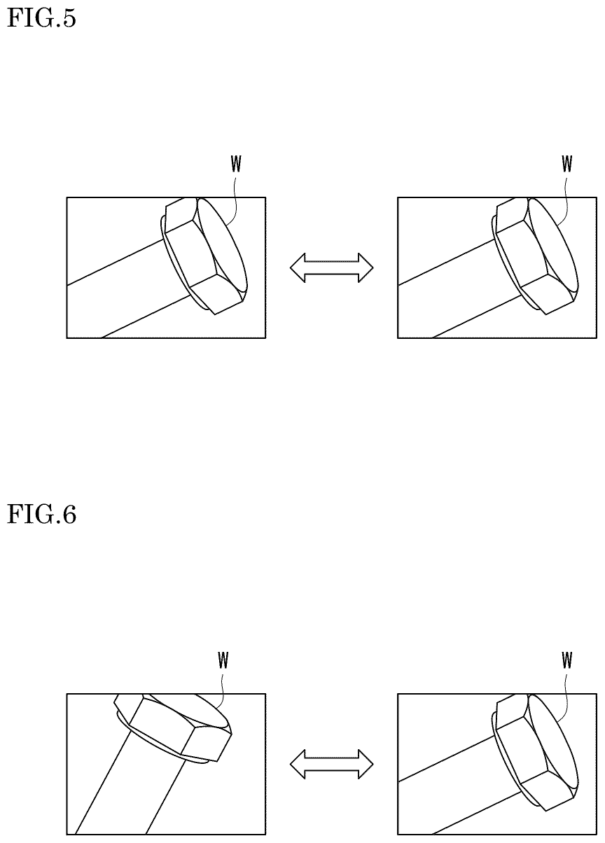

FIG. 5 includes diagrams for explaining an operation to compare images. The image on the right side in FIG. 5 is the estimated image information generated by the estimated image information generating section 22b. The image on the left side in FIG. 5 is the image of the workpiece W imaged by the imaging device 13 in the state shown in FIG. 4 (i.e. the actual image information). As shown in FIG. 5, when the estimated image information and the actual image information are substantially the same, it can be determined that the workpiece W has not moved.

FIG. 6 shows images when the workpiece W has moved. The image on the right side in FIG. 6 is an estimated image information generated by the estimated image information generating section 22b. The image on the left side in FIG. 6 is the image of the workpiece W imaged by the imaging device 13 in the state shown in FIG. 4 (i.e. the actual image information). As shown in FIG. 6, when the estimated image information and the actual image information do not match each other (including the case where it is considered that they do not match each other), it can be determined that the workpiece Whas moved. The determination on whether the workpiece W has moved or not can be performed based on the image information obtained not only when the imaging device 13 is located in the measurable range but also when the imaging device 13 is located outside the measurable range.

The image information update section 22d determines whether the image information held in the object information holding section 22a should be updated or not in the case where the estimated image information and the actual image information are substantially the same image information (i.e. it is determined that the workpiece W has not moved) in the comparison processing by the comparison section 22c. As a result, if it is necessary, the image information update section 22d updates the image information to be held.

Specifically, the predetermined position closer to the workpiece W may be the position where the imaging device 13 is located in the measurable range or may be the position where the imaging device 13 is located outside the measurable range. Since the measurable range of the imaging device 13 is recognized in advance as described above, it is possible to recognize the posture of the robot arm 12 based on the control instruction information transmitted to the robot unit 1. Accordingly, the position of the imaging device 13 can also be specified, and thus it is possible to determine whether the imaging device 13 is located in the measurable range or not.

The image information update section 22d determines whether the image information held in the object information holding section 22a should be updated or not in the case where the estimated image information and the actual image information are substantially the same image information and furthermore the imaging device 13 is located in the measurable range.

Specifically, the image information update section 22d compares the previous image information (for example, the image information obtained by the initial imaging operation) to the actual image information (for example, the image information obtained by the imaging operation at a position closer to the workpiece W than the position where the initial imaging operation is performed), both imaged by the imaging device 13. That is, when a plurality of pieces of image information can be obtained by imaging by the imaging device 13 at respective positions having different distances to the workpiece W and from where the distance information can be acquired, the plurality of pieces of image information are compared. The image information update section 22d causes the object information holding section 22a to hold the object information including the distance information of the workpiece W (i.e. to update the object information), which is calculated based on the image information obtained at a position having the closest distance to the workpiece W out of the pieces of image information. This is because the image (image information) obtained by imaging by the imaging device 13 generally can be obtained as clear image information as the distance from the workpiece W is reduced. Thus, by causing the object information holding section 22a to hold the object information including the distance information of the workpiece W, which is calculated based on the image information obtained at a position having the closest distance to the workpiece W, it is possible to highly accurately recognize the distance to the workpiece W.

Alternatively, the image information update section 22d may compare the previous image information to the actual image information imaged by the imaging device 13 so as to select the clearest image information, and thus may cause the object information holding section 22a to hold the object information including the distance information of the workpiece W, which is calculated based on thus selected image information. For example, the image information update section 22d compares the previous image information to the actual image information so as to select clearer image information (for example, image information in focus and image information without missing part due to reflection of light or the like), and thus causes the object information holding section 22a to hold the object information including the distance information of the workpiece W, which is calculated based on the selected image information. In this way also, it is possible to highly accurately recognize the distance to the workpiece W.

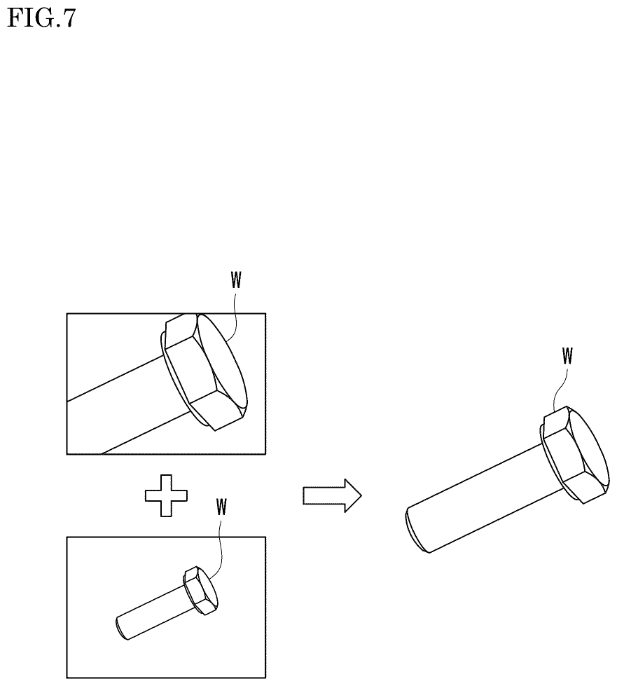

Also, the image information update section 22d may compare the previous image information to the actual image information imaged by the imaging device 13, and when both pieces of image information each have a missing part (for example, a missing part of the image information due to reflection of light or the like) and furthermore when the respective missing parts are different from each other, the image information update section 22d may complement the missing part of one image with the other image (image not having this missing part). That is, the image information update section 22d may synthesize the previous image information and the actual image information to generate new image information, and thus may cause the object information holding section 22a to hold the object information including the distance information of the workpiece W, which is calculated based on the new image information. FIG. 7 includes diagrams for explaining synthesis processing of two images. The image at the lower left of FIG. 7 is the previous image information (for example, the image information obtained by the initial imaging operation), and the image at the upper left is the actual image information (for example, the image information obtained by the image operation at the position closer to the workpiece W than the position where the initial imaging operation is performed). Although they are not shown in the figures, a missing part exists in each pieces of the image information. By synthesizing these images, the missing part of one image is complemented with the other image, and the image (synthesized image) on the right side of FIG. 7 is generated. In this way, the highly accurate image information is generated. Thus, by causing the object information holding section 22a to hold the object information including the distance information of the workpiece W, which is calculated based on the synthesized image information, it is possible to highly accurately recognize the distance to the workpiece W.

As to the update of the image information in the object information holding section 22a by the image information update section 22d, when the imaging device 13 takes, intermittently, the images of the workpiece W multiple times while approaching the workpiece W in the state in which the imaging device 13 is located in the measurable range during the multiple imaging operations, the image information update section 22d determines whether or not the image information held in the object information holding section 22a should be updated every time the imaging operation is performed. As a result, if it is necessary, the image information update section 22d updates the image information to be held.

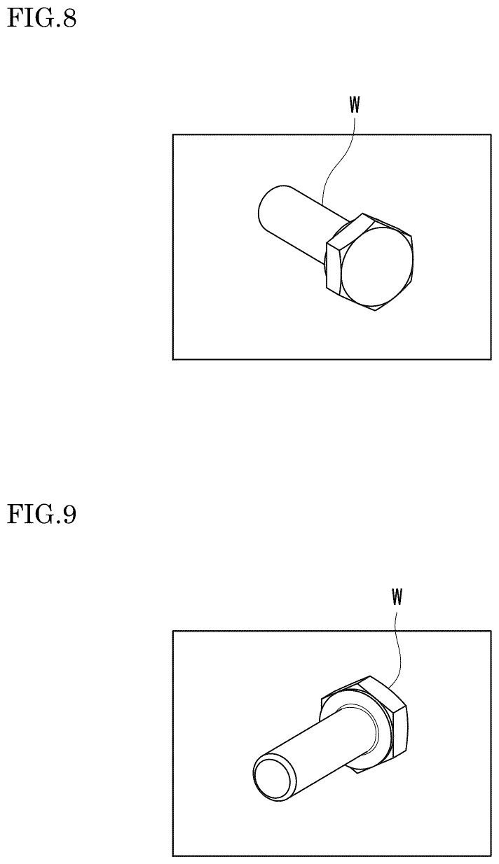

The viewpoint change instruction section 22e has a function to transmit the control instruction information to the robot unit 1. This control instruction information is to image the workpiece W by the imaging device 13 from the imaging direction other than the imaging direction from which the actual image information is obtained by the imaging device 13, in the case where the estimated image information and the actual image information are substantially the same and thus it is determined that the workpiece W has not moved, as a comparison result by the comparison section 22c. That is, in order to perform stable gripping of the workpiece W by the robot hand 14, it is preferable to grip the center position or the center of gravity position of the workpiece W, and for this reason, it is necessary to recognize the general shape of the workpiece W. The viewpoint change instruction section 22e is a function section to recognize the general shape of the workpiece W by changing the imaging direction from which the workpiece W is imaged by the imaging device 13 from the above-described direction to another direction. FIG. 8 is a diagram exemplarily indicating an image of the workpiece W obtained by the imaging operation from a first different viewpoint. FIG. 8 shows the image of the workpiece W imaged by the imaging device 13 that comes around on the side of the head part of the workpiece (bolt) W. Also, FIG. 9 is a diagram exemplarily indicating an image of the workpiece W obtained by the imaging operation from a second different viewpoint. FIG. 9 shows the image of the workpiece W imaged by the imaging device 13 that comes around on the side of the thread part of the workpiece (bolt) W. In this way, by imaging the workpiece W from various directions to recognize the general shape, it is possible to grip the center position or the center of gravity position of the workpiece W.

The control switching section 22f performs the operation to grip the workpiece W by the robot hand 14 using the distance information held in the object information holding section 22a in the case where the estimated image information and the actual image information (substantially) match each other (including the case where it is considered that they match each other) as a comparison result by the comparison section 22c. In this way, when the actual image information imaged by the imaging device 13 at the position outside the measurable range matches the estimated image information, it is determined that the workpiece W has not moved, although the distance information cannot be acquired from the actual image information. Thus, it is possible to grip the workpiece W using the distance information held in the object information holding section 22a, and the operation to grip the workpiece W is performed using the distance information held in the object information holding section 22a. More specifically, in this embodiment, the workpiece W placed on the predetermined position of the first workbench is gripped by the robot hand 14, and is transported, by the operation of the robot arm 12, to the predetermined position of the second workbench.

On the other hand, the control switching section 22f does not perform the operation to grip the workpiece W using the distance information held in the object information holding section 22a in the case where the estimated image information and the actual image information do not match each other (including the case where it is considered that they do not match each other) as a comparison result by the comparison section 22c. In this case, the object information held in the object information holding section 22a is deleted, and the initial imaging operation as described above is performed once again so as to perform the operation to hold the object information including the distance information in the object information holding section 22a.

### Object Gripping Operation

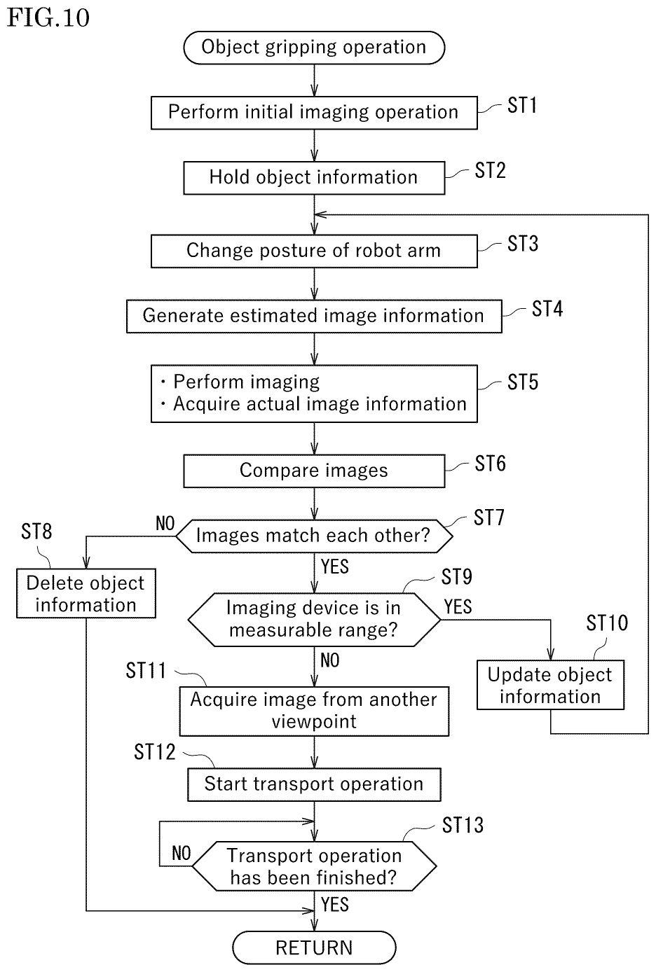

Here an object gripping operation by the above robot control system 20 is described. FIG. 10 is a flowchart indicating a processing procedure for the object gripping operation. The procedure in this flowchart is repeatedly performed every time the request to grip the workpiece W (i.e. the request to transport the workpiece W from the position on the first workbench to the position on the second workbench) arises.

When the request to grip the workpiece W arises, the initial imaging operation is executed in step ST1. That is, the movement of the robot arm 12 is controlled such that the imaging device 13 is located in the measurable range, and the image information is obtained by imaging the workpiece W by the imaging device 13 at the position. In step ST2, the object information including the distance information of the workpiece W, which is calculated based on the image information, is transmitted to the object information holding section 22a via the input/output section 24, and thus held in the object information holding section 22a.

In step ST3, the posture of the robot arm 12 is changed such that the robot arm 12 approaches the workpiece W. Then, in step ST4, the estimated image information is generated, which is estimated to be obtained by imaging by the imaging device 13 at the predetermined position after change of the posture when it is assumed that the workpiece W has not moved for a period when the robot arm 12 moves together with the imaging device 13 to the predetermined position.

In step ST5, the imaging by the imaging device 13 is performed at the predetermined position described above so as to acquire the actual image information by this imaging.

In step ST6, the estimated image information is compared to the actual image information. When these images are different from each other (i.e. the images differ from each other due to movement of the workpiece W), and thus it is determined to be “NO” in step ST7, the procedure advances to step ST8 where the object information held in the object information holding section 22a is deleted, and the procedure returns. In this way, the above-described initial imaging operation is performed once again, and the operation is performed to hold, in the object information holding section 22a, the object information including the distance information of the workpiece W after movement.

When the estimated image information and the actual image information match each other and thus it is determined to be “YES” in step ST7, the procedure advances to step ST9 where it is determined whether the actual position of the imaging device 13 is in the measurable range or not. When the actual position of the imaging device 13 is in the measurable range and thus it is determined to be “YES” in step ST9, the procedure advances to step ST10 where the update operation of the image information is performed by the above-described image information update section 22d, and then the procedure returns to step ST3. In this way, when the imaging by the imaging device 13 is performed in the state in which the position of the imaging device 13 is in the measurable range, the object information held in the object information holding section 22a is sequentially updated and thus the object information including the highly accurate distance information is held in the object information holding section 22a.

On the other hand, when the actual position of the imaging device 13 is outside the measurable range and thus it is determined to be “NO” in step ST9, the procedure advances to step ST11 where the image from another viewpoint is acquired by changing the imaging direction of the workpiece W by the imaging device 13 to the direction different from the above-described direction. For example, the imaging operation from the above-described first different viewpoint (i.e. the operation to acquire the image of the workpiece W shown in FIG. 8) or the imaging operation from the above-described second different viewpoint (i.e. the operation to acquire the image of the workpiece W shown in FIG. 9) is executed. In this way, it is possible to recognize the general shape of the workpiece W, and accordingly it is possible to grip the center position or the center of gravity position of the workpiece W.

After that, in step ST12, the object information including the distance information held in the object information holding section 22a is read out so as to execute the operation to grip the workpiece W using the read object information, and thus the operation to transport the workpiece W is started.

In step ST13, it is determined whether the operation to transport the workpiece W has been finished or not. When the operation to transport the workpiece W has been finished and thus it is determined to be “YES” in step ST13, the robot arm 12 returns to the initial position and the procedure returns. The above procedure is repeatedly performed.

### Effects of Embodiment

In this embodiment as described above, at the time when the workpiece W is subjected to the gripping operation by the robot hand 14, the actual image information is compared to the estimated image information. The actual image information is the image information of the workpiece W obtained by imaging by the imaging device 13 at the predetermined position closer to the workpiece W from the position having the predetermined distance from the workpiece W, while the estimated image information is the image information of the workpiece W estimated to be obtained by imaging by the imaging device 13 at the predetermined position when it is assumed that the workpiece W has not moved for a period when the robot arm 12 moves together with the imaging device 13 to the predetermined position. As a comparison result, when the estimated image information and the actual image information match each other or are considered to be the same, the operation to grip the workpiece W is executed using the object information including the distance information held in the object information holding section 22a. Therefore, it is possible to appropriately grip the workpiece W while determining whether the workpiece W has moved or not when the robot arm 12 is approaching the workpiece W.

### Other Embodiments

The present invention is not limited to the above-described embodiment. All modifications and changes that come within the meaning and range of equivalency of the claims are intended to be embraced therein.

For example, in the above-described embodiment, the present invention is disclosed as the robot control system 20 that controls the collaborative robot. However, the present invention is not limited thereto, and applicable to industrial robots. Also, in the above-described embodiment, the control to grip the workpiece W by the robot hand 14 is exemplarily explained. However, the present invention is not limited thereto, and applicable to various operations for the workpiece W such as processing of the workpiece W.

Also in the above-described embodiment, the imaging device 13 is a passive type imaging device. However, the present invention is not limited thereto. The imaging device 13 may be an active type imaging device.

Also in the above-described embodiment, the viewpoint change instruction section 22e is provided as a function part of the robot control system 20 so that the workpiece W is imaged by the imaging device 13 from a different direction when the estimated image information and the actual image information match each other. However, the present invention is not limited thereto. The viewpoint change instruction section 22e is not necessarily required to be provided, that is, it is not necessarily required to perform the imaging of the workpiece W by the imaging device 13 from a different direction.

As to the comparison operation by the comparison section 22c, the estimated image information may be compared to a synthesized image (a new image information made by synthesizing the previous image information and the actual image information; see FIG. 7). In this case, it is necessary to match the position of the workpiece W of the synthesized image and the position of the workpiece W for generating the estimated image information (i.e. the position of the workpiece W when it is assumed that the workpiece W has not moved). Taking into account the above, the term “actual image information of the object” in the present invention is a concept including the synthesized image made by a plurality of pieces of actual image information.

### INDUSTRIAL APPLICABILITY

The present invention is applicable to a robot control system to grip an object while measuring a distance to the object by imaging the object by an imaging device provided on a tip part of a robot arm.

This application claims priority based on Patent Application No. 2023-058133 filed in Japan on Mar. 31, 2023. The entire contents thereof are hereby incorporated in this application by reference.

### DESCRIPTION OF THE REFERENCE NUMERALS

11 Robot
12 Robot arm
13 Imaging device
20 Robot control system
22a Object information holding section
22b Estimated image information generating section
22c Comparison section
22d Image information update section
22e Viewpoint change instruction section
22f Control switching section
W Workpiece (object)

1. A robot control system to control, based on image information of an object, a robot treating the object, the image information obtained by imaging the object by an imaging device provided on a robot arm of the robot, the robot control system comprising:
an object information holding section holding object information including distance information of the object, the distance information being calculated based on the image information obtained by imaging by the imaging device located at a position having a predetermined distance from the object;
an estimated image information generating section generating estimated image information of the object based on the object information held in the object information holding section, the estimated image information being estimated to be obtained by imaging by the imaging device at a predetermined position closer to the object in a case where it is assumed that the object has not moved for a period when the robot arm moves together with the imaging device from the position having the predetermined distance from the object to the predetermined position closer to the object;
a comparison section comparing the estimated image information generated by the estimated image information generating section to actual image information of the object, the actual image information being obtained by imaging by the imaging device at the predetermined position closer to the object; and
a control switching section that preforms an operation to treat the object using the distance information held in the object information holding section when the actual image information and the estimated image information match each other as a comparison result by the comparison section, and that does not perform the operation to treat the object using the distance information held in the object information holding section when the actual image information and the estimated image information do not match each other.

2. The robot control system according to claim 1, wherein
when the control switching section does not perform the operation to treat the object, the object information held in the object information holding section is deleted, and imaging by the imaging device is performed at the position having the predetermined distance from the object so as to perform once again an operation to hold the object information including the distance information in the object information holding section.

3. The robot control system according to claim 1, further comprising an image information update section, wherein
when a plurality of pieces of image information is obtained by imaging by the imaging device at respective positions that have different distances to the object and from where the distance information is acquired, the image information update section causes the object information holding section to hold the object information including the distance information of the object, the object information being calculated based on the image information obtained at a position having the closest distance to the object.

4. The robot control system according to claim 1, further comprising an image information update section, wherein
when a plurality of pieces of image information is obtained by imaging by the imaging device at respective positions that have different distances to the object and from where the distance information is acquired, the image information update section selects the clearest image information and causes the object information holding section to hold the object information including the distance information of the object, the object information being calculated based on the selected image information.

5. The robot control system according to claim 1, further comprising an image information update section, wherein
when a plurality of pieces of image information is obtained by imaging by the imaging device at respective positions that have different distances to the object and from where the distance information is acquired, the image information update section synthesizes the plurality of pieces of image information and causes the object information holding section to hold the object information including the distance information of the object, the object information being calculated based on the synthesized image information.

6. The robot control system according to claim 1, further comprising a viewpoint change instruction section, wherein
when the actual image information and the estimated image information match each other as the comparison result by the comparison section, the viewpoint change instruction section causes the imaging device to image the object from a direction different from the imaging direction of the imaging device from which the actual image information is obtained.
